(19) United States
(12) Patent Application Publication
(10) Pub. No.: US 2011/0234151 A1
(43) Pub. Date: Sep. 29, 2011

(54) PLATFORM WITH POWER BOOST

(76) Inventors: Alexander B. Uan-Zo-li, Hillsboro, OR (US); Andrew W. Keates, Los Gatos, CA (US)

(21) Appl. No.: 12/732,793

(22) Filed: Mar. 26, 2010

(51) Int. Cl. H02J 7/00; H02J 7/04

(52) U.S. Cl. 320/107; 320/137; 320/162

(57) ABSTRACT

Disclosed herein are approaches involving using both an adapter and a battery at the same time for powering a computer platform.

### TECHNICAL FIELD

The present invention relates generally to battery chargers and power delivery systems and in particular, to power delivery for platforms with chargeable supplies.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a circuit diagram showing a conventional adaptor-battery-charger system for a computing platform.

FIG. 2A illustrates a traditional mode with an adapter providing power to both a battery pack and to the platform load.

FIG. 2B illustrates a boost mode for an adapter and battery pack both to provide power to a platform load.

FIG. 3 is a circuit diagram showing an adaptor-battery-charger power system with a boost mode capability for a computing platform.

FIG. 4 is a simplified diagram of the power system of FIG. 3.

FIG. 5 shows the diagram from FIG. 4 drawn to demonstrate the circuit configuration when the adapter is connected to the system.

FIG. 6 shows a portion of an exemplary charger controller circuit with boost capability in accordance with some embodiments.

FIG. 7 shows simulation results for the adaptor-charger-battery system of FIG. 6 at when the platform power consumption levels is changing from the level below the adapter capability to the level above adapter capability.

FIG. 8 shows results from FIG. 7 focused on the adapter providing power to the battery and the platform.

FIG. 9 shows results from FIG. 7 focused on the battery supplementing the adapter to provide power to the platform.

### DETAILED DESCRIPTION

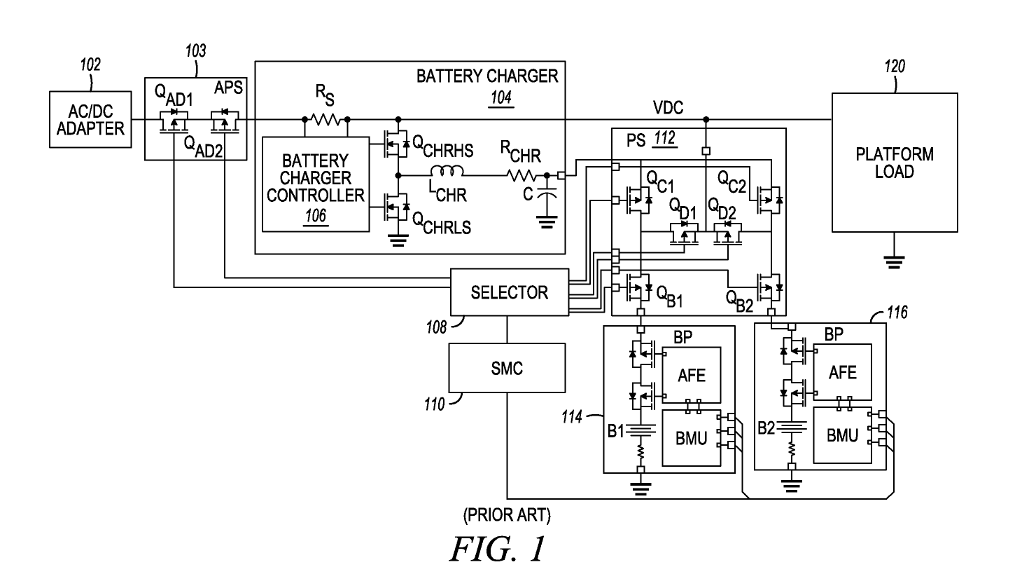

FIG. 1 is a circuit diagram showing a conventional adaptor-battery-charger system for providing power to a computing platform. It generally comprises an AC/DC adapter 102, adapter protection switches (APS) 103, battery charger 104, selector 108, system management controller (SMC) 110, power switch (PS) network 112, and battery packs 114, 116, connected together as shown. As used herein, the term “computing platform” refers to any processor based device amenable to the principles presented herein including but not limited to a laptop, a netbook, a tablet, or a cellular phone, although a portable personal computer such as a so-called notebook personal computer may be used as a primary example for purposes of describing the technologies presented herein. It should be appreciated that the depicted power system blocks may be incorporated, in whole or in part, in the computing platform and in fact, in some embodiments, the components, apart from the adapter, are part of the platform for providing power to the platform load 120, e.g., the various parts of the computing platform such as the processor, display, cooling system, etc, make up the platform load 120.

The adapter is connected to the platform through two protection switches Q_{ad1} and Q_{ad2} within the APS 103. The adapter provides a DC supply voltage to the platform 120, which then typically converts it, as may be internally needed within the platform, using one or more DC-to-DC converters within the platform. As an example, for platforms such as tablets, netbooks or notebook portable computing platforms, an adapter may provide a DC supply of about 19 to 20 VDC directly to the computing platform load 120. On the other hand, the battery packs may provide a lower supply voltage, e.g., from 9 to 12 VDC with the present example. The platform is typically capable of receiving a wide range of input supply voltages (e.g., higher voltages from adapters and lower voltages from the battery packs) and converting them to suitable internal levels. In many cases, the platform steps down both the adapter and the battery supplies to levels, e.g., ranging from less than 1.0 V to 5 VDC.

The battery charger 104 provides power from the adapter 102 to the battery packs 114, 116, when the adapter is available. Since, as just discussed, the adapter's output voltage is typically greater than the supplies from the battery packs, the battery charger typically comprises a step-down DC-DC converter to convert the higher adapter voltage (e.g., 19-20 V) to the lower battery voltage (e.g., 9-12 V). In the depicted figure, the battery charger 104 comprises a synchronous buck-type converter formed from switches Q_{CHRHS}/Q_{CHRLS}, inductor L_{CHR} (with series resistance indicated as R_{CHR}) and capacitor C, connected together and operated as is commonly known in the art.

The selector 108, which is typically controlled by the SMC 110, controls various power switches including those in the power switch network 112 for coupling the appropriate battery pack to the charger 104 and/or to the platform 106. It also may control the APS 103 for coupling the adapter to the platform load 120. When the adapter 102 is disconnected, a battery pack, 114 or 116, provides full platform power through switches Q_{d1} or Q_{d2} within the PS 112. (Note that there may also be an embedded power controller, not shown, for managing overall platform power, as well as possibly other environmental parameters.)

With computing platforms, it may be desirable at times (e.g., when operating temperatures are sufficiently low) for some platform components (e.g., one or more processor cores and/or graphic processors) to be driven to higher performance modes. For example, during such modes (hereafter referred to as “boost” modes), one or more components may be driven harder for periods ranging, e.g., from hundreds of microseconds to tens of seconds. Unfortunately, this may require larger amounts of power than the adapter is capable of reliably providing.

Accordingly, disclosed herein are approaches involving using both the adapter and the battery (or other energy storage device or a combination of energy storage devices) at the same time to provide power to the platform during such boost modes. Persons skilled in the art should understand that such a mode of operation can be allowed if the system confirms that the battery is charged to sufficient levels to support it.

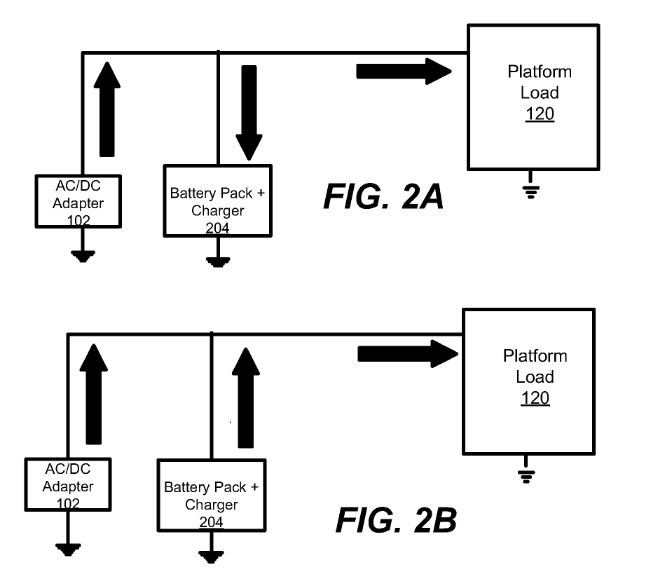

FIGS. 2A and 2B depict this approach in accordance with some embodiments. FIG. 2A shows that in a normal mode (e.g., a charging mode), when the platform input power is below the adaptor capability, the operation of the adapter and battery charger system may be the same as with contemporary schemes. The adapter provides power to the platform, as well, possibly, to the battery charger to charge the battery.

On the other hand, FIG. 2B represents a system with a boost mode capability whereby both the adapter and battery pack provide power to the platform. In some embodiments, when the adapter power output is exceeded by the platform demand and the battery pack is connected to the platform and has a sufficient state of charge, then the battery charger is used in a reversed mode by the platform controller as a synchronous boost converter to supplement the adaptor power to the platform load 120, as depicted in FIG. 2B.

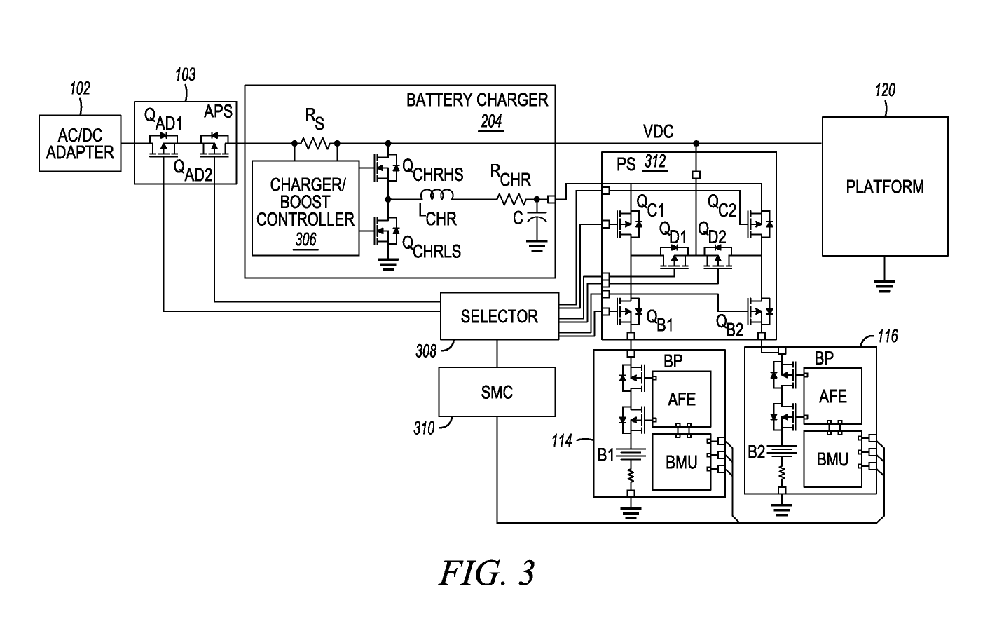

FIG. 3 shows a power system for a platform in accordance with some embodiments. It is similar to the power system of FIG. 1, except that, among other things, it includes a battery charger controller 306 that is configured to control the charger converter components to operate in both buck (step down charge) and boost (step up, power boost) modes. Other blocks may be modified and/or augmented to facilitate particular design considerations.

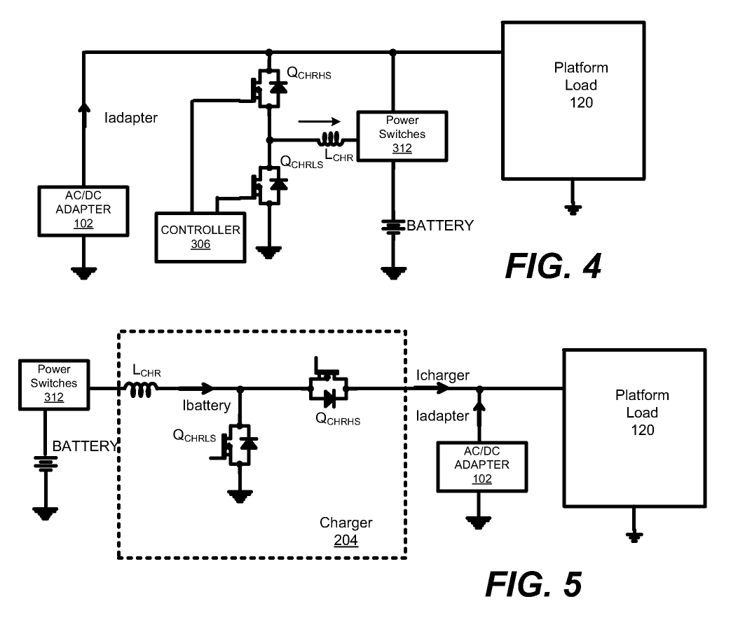

FIGS. 4 and 5 are simplified diagrams of the power system of FIG. 3 for ease of understanding relevant aspects of the invention. For the power switch (PS) block 312, it can be assumed to include the Q_{D1}, Q_{D2} switches, with the Q_{B1}, Q_{B2}, Q_{C1}, and Q_{C2} switches excluded. The figures highlight the charger 204, controller 306 and the components of the charger's synchronous buck converter. As indicated, the synchronous buck converter (Q_{CHRHS}, Q_{CHRLS}, L_{CHR}) is inherently a two-quadrant power supply, i.e. its power stage can be operated as a power source and a power sink without having to change the essential power elements of the power circuitry.

With reference to FIG. 4, when the platform load power demand is to be less than the adapter upper-end output power level, then the adapter may be allowed to charge the battery, and the charger is in charge mode. The charger acts as a synchronous buck converter. Its input voltage comes from the adapter supply and is thus equal to he adapter's output supply voltage. Its output voltage is the battery voltage, and the duty cycle for the switch Q_{CHRHS} may, in some embodiments, be the ratio between the output voltage and input voltage (switches Q_{CHRHS} and Q_{CHRLS} are complementary).

On the other hand, with reference to FIG. 5, when the platform power exceeds the adapter power capabilities, the charger goes into boost mode, and the battery acts as a supplemental energy source for the platform load. In this mode, the charger acts as a synchronous boost converter. Its input voltage is the battery voltage, and its output voltage is the adapter voltage. The duty cycle for the switch Q_{CHRHS} may be the ratio between the input voltage and output voltage (switches Q_{CHRHS} and Q_{CHRLS} are complementary).

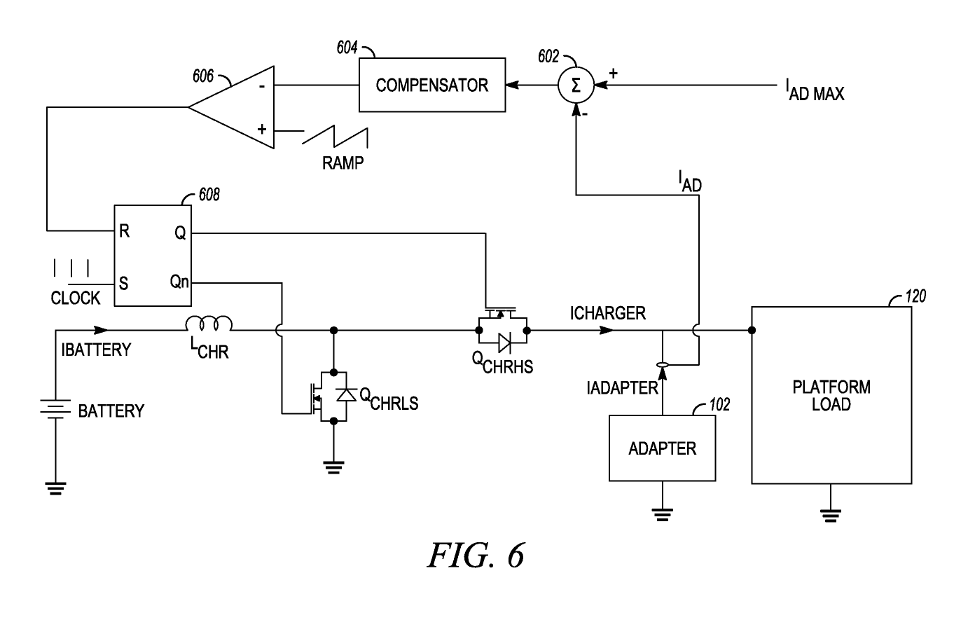

FIG. 6 shows a circuit that may be suitable for at least a portion of controller 306 and is used to demonstrate the invention. It allows for seamless transition of the charger between charging the battery in normal charge mode and boosting the platform load power by using the battery stored energy during a boost mode. This circuit comprises a summer (error amplifier) 602, a compensator 604, a differential amplifier 606, and an RS flip-flop 608, coupled as shown to the charger components, adapter, and battery. The circuit constitutes a well-known PWM controller for controlling a synchronous buck or boost converter. The Clock and Ramp (saw tooth) signals are typically in phase and at the same frequency, e.g., around 100 KHz. The compensator 604 may comprise a filter (e.g., a low-pass filter with a pole at or near the Clock frequency) to smooth the error signal from the output of the summer 602, to stabilize the system, provide necessary amplification of the error signal and generate a desired transient response.

The summer and compensator control the charger duty cycle based on the difference between the sensed adapter current (e.g., via sense resistor such as the sense resistor R_{S} in FIG. 3) and the adapter reference current, which in this case is chosen to be the adapter's rated maximum average operating current. The flip-flop and the clock control the duty cycle and the switching frequency of the switches (Q_{CHRHS}, Q_{CHRLS}) so that the average adapter current (I_{AD}) is at the maximum set value. Of course, specific additional details of the control implementation may vary as to accommodate better transient characteristics, e.g., hysteretic control, constant on time and constant off-time control, etc.—as well as different modes of battery charging, system, battery and adapter protection, etc.

Since the controller controls the adapter current to be driven to its maximum level, the switches will function, in cooperation with the inductor (L_{CHR}) so that charger current (I_{Charger}) is in the direction as indicated by the arrow, when the platform load demand is larger than the adapter maximum level and to be in the opposite direction (to charge the battery) when the platform load demand is less than the adapter maximum level. On a separate point, since the maximum adapter current level, the set reference input to summer 602, is defined by design, the maximum current rating of the AC adapter should be identified or assumed.

(Note that more complicated charging schemes may be incorporated for the battery and specific charging current profiles can be easily accommodated by anyone familiar with the art).

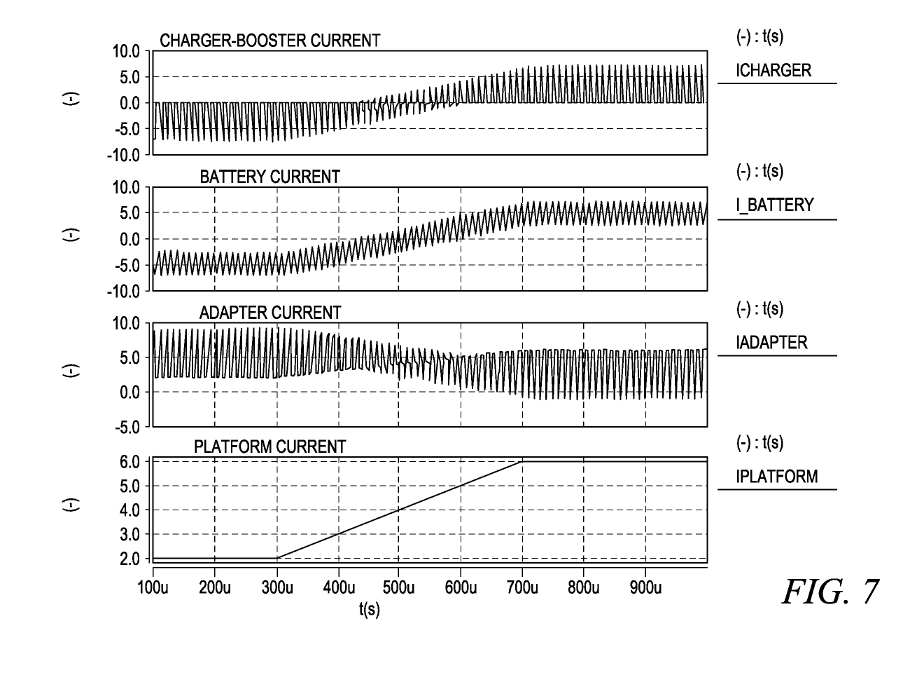

FIGS. 7, 8 and 9 demonstrate a computer simulated performance of the power system with a control scheme such as the one from FIG. 6. FIG. 7 shows the system at different platform power consumption levels. It shows the system performance when the platform input current transitions from 2 Amps to 6 Amps, and the battery charger starts boosting the platform power by discharging the battery when the platform current goes above 4 Amps (the set limit for the adapter average output current in this example).

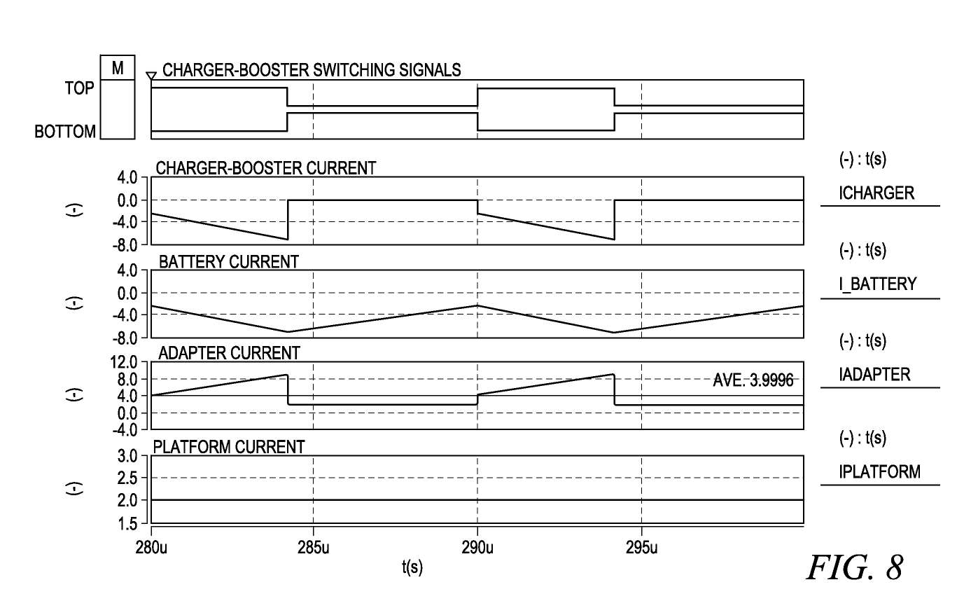

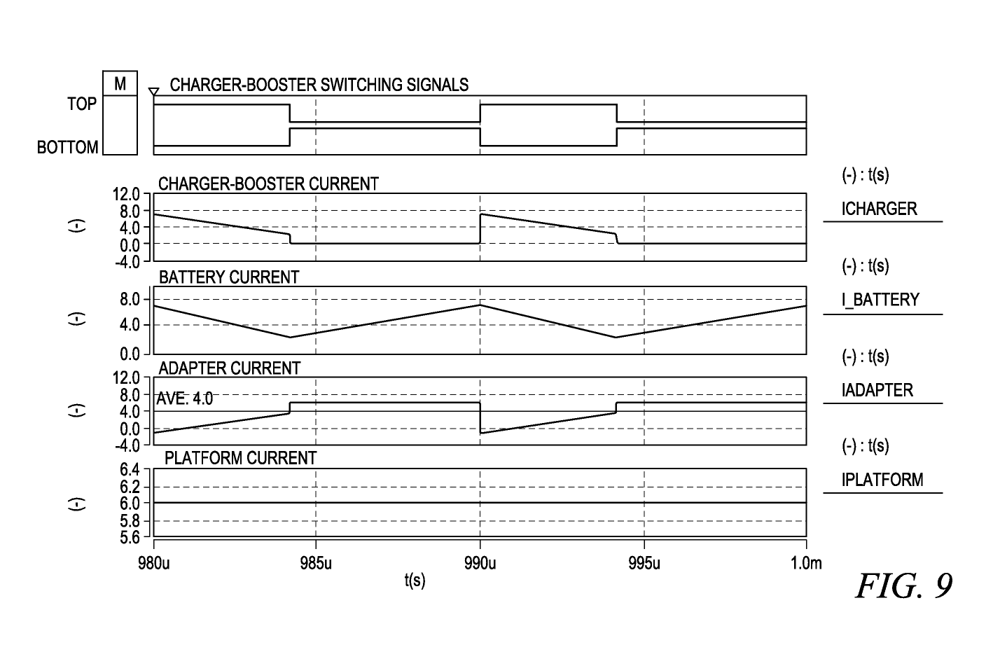

FIGS. 8 and 9 zoom into different portions of FIG. 7 in order to demonstrate the steady state operation of the system for a steady-state platform current for the duration of 2 switching cycles. Note that the adapter average output current stays constant at 4A at all levels of the platform input current, even though it would appear from FIG. 7 that the adaptor output current changes at different instances. FIG. 8 shows the operation of the system when the platform current is below the adapter current rating (adapter maximum current at 4A), and the adapter is providing power to the platform and to charge the battery pack. The battery current is negative (it is being charged), it is a saw-tooth shape as is expected for the buck converter. The adaptor current is a combination of a saw-tooth—and square-wave like shapes because its current is the sum of the platform input current and the pulsating input current of the charger which is used as a buck converter.

FIG. 9 shows the operation of the system when the platform current is above the adapter current rating and the adapter and the battery pack are providing power to the platform. The battery current is positive (the battery is delivering its energy to the platform). It is a saw-tooth shape as is expected for the boost converter. The adaptor current is a combination of a saw-tooth—and square-wave like shapes because its current is the difference of the platform input current and the pulsating output current of the charger which is used as a boost converter.

In the preceding description, numerous specific details have been set forth. However, it is understood that embodiments of the invention may be practiced without the enumerated specific details. In other instances, well-known circuits, structures and techniques may have not been shown in detail in order not to obscure an understanding of the description. With this in mind, references to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the preceding description and following claims, the following terms should be construed as follows: The terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not be in direct physical or electrical contact.

The term “PMOS transistor” refers to a P-type metal oxide semiconductor field effect transistor. Likewise, “NMOS transistor” refers to an N-type metal oxide semiconductor field effect transistor. It should be appreciated that whenever the terms: “MOS transistor”, “NMOS transistor”, or “PMOS transistor” are used, unless otherwise expressly indicated or dictated by the nature of their use, they are being used in an exemplary manner. They encompass the different varieties of MOS devices including devices with different VTs, material types, insulator thicknesses, gate(s) configurations, to mention just a few. Moreover, unless specifically referred to as MOS or the like, the term transistor can include other suitable transistor types, e.g., junction-field-effect transistors, bipolar-junction transistors, metal semiconductor FETs, and various types of three dimensional transistors, MOS or otherwise, known today or not yet developed.

The invention is not limited to the embodiments described, but can be practiced with modification and alteration within the spirit and scope of the appended claims. For example, it should be appreciated that the present invention is applicable for use with all types of semiconductor integrated circuit (“IC”) chips. Examples of these IC chips include but are not limited to processors, controllers, chip set components, programmable logic arrays (PLA), memory chips, network chips, and the like.

It should also be appreciated that in some of the drawings, signal conductor lines are represented with lines. Some may be thicker, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

It should be appreciated that example sizes/models/values/ranges may have been given, although the present invention is not limited to the same. As manufacturing techniques (e.g., photolithography) mature over time, it is expected that devices of smaller size could be manufactured. In addition, well known power/ground connections to IC chips and other components may or may not be shown within the FIGS, for simplicity of illustration and discussion, and so as not to obscure the invention. Further, arrangements may be shown in block diagram form in order to avoid obscuring the invention, and also in view of the fact that specifics with respect to implementation of such block diagram arrangements are highly dependent upon the platform within which the present invention is to be implemented, i.e., such specifics should be well within purview of one skilled in the art. Where specific details (e.g., circuits) are set forth in order to describe example embodiments of the invention, it should be apparent to one skilled in the art that the invention can be practiced without, or with variation of, these specific details. The description is thus to be regarded as illustrative instead of limiting.

What is claimed is:

1. An apparatus, comprising:
a platform load; and
a charger to step down a voltage from an adapter to charge a battery during a charge mode, the charger to step up the battery voltage to provide current, along with the adapter, to the platform load during a boost mode.

2. The apparatus of claim 1, in which the charger comprises an inductor and first and second switches to function as a synchronous buck converter during the charge mode.

3. The apparatus of claim 2, in which the inductor and first and second switches function as a synchronous boost converter during the boost mode.

4. The apparatus of claim 1, in which the platform load and charger are part of a common chassis.

5. The apparatus of claim 4, in which the platform load comprises a processor for a mobile computer.

6. The apparatus of claim 1, in which the boost mode occurs when sufficiently high current is required by the platform load.

7. The apparatus of claim 1, in which the charge mode occurs when the platform load requires sufficiently low current and the battery is ready for charging.

8. The apparatus of claim 1, in which the charger is controlled so that the adapter sources a maximum average operating current.

9. A method, comprising:
providing current from an adapter to a platform load and to a battery during a charge mode; and
providing current from the adapter and the battery to the platform load during a boost mode.

10. The method of claim 9, comprising providing a maximum average operating current from the adapter during both the charge and boost modes.

11. The method of claim 9, in which providing current from the battery to the platform load comprises stepping up the voltage from the battery to that of the adapter using a boost converter operating in parallel with the adapter circuitry.

12. The method of claim 11, in which providing current from the adapter to the battery comprises stepping down the voltage of the adapter to that of the battery using a buck converter.

13. The method of claim 12, in which the buck and boost converter are formed from a common inductor and common power switches.

14. A computing platform, comprising
platform loads;
a battery pack; and
a battery charger including first and second power switches and an inductor, the charger to cause the adapter to charge the battery during a charge mode and to cause the battery to provide current with the adapter to the platform loads during a boost mode.

15. The computing platform of claim 14, in which the charger steps down a voltage from an adapter to the battery pack during the charge mode.

16. The computing platform of claim 15, in which the charger steps up the battery voltage to the adapter voltage during the boost mode.

17. The computing platform of claim 14, in which the first and second power switches and inductor operate as a buck converter during the charge mode and operate as a boost converter during the boost mode.
